(19) United States
(12) Patent Application Publication
(10) Pub. No.: US 2026/0349292 A1
(43) Pub. Date: Nov. 5, 2026

(54) DISPLAY MODULE AND DISPLAY DEVICE

(71) Applicant: SHANGHAI TIANMA MICROELECTRONICS CO., LTD., Shanghai (CN)

(72) Inventors: Yuanyuan WU, Shanghai (CN); Qijun YAO, Shanghai (CN)

(73) Assignee: SHANGHAI TIANMA MICROELECTRONICS CO., LTD., Shanghai (CN)

(21) Appl. No.: 19/724,959

(22) Filed: Jun. 30, 2026

(30) Foreign Application Priority Data
Mar. 16, 2026 (CN) 202610322455.8

(51) Int. Cl. G02F 1/13; G02F 1/167; G02F 1/1676; G02F 1/1681

(52) U.S. Cl. CPC G02F 1/1323; G02F 1/167; G02F 1/1676; G02F 1/1681

(57) ABSTRACT

A display module and a display device are provided. The display module includes a display structure and a viewing angle adjustment structure disposed at a light-exiting side of the display structure; the display module includes a display area and a non-display area; the viewing angle adjustment structure includes an electrophoretic liquid layer and a first substrate disposed at a side of the electrophoretic liquid layer away from the display structure; the electrophoretic liquid layer is provided with partitions; the display module further includes a sealant structure disposed in the non-display area; the sealant structure includes a spacer, the sealant structure includes an opening, and the first partition is disposed in the opening; in a direction perpendicular to a plane where the display module is located, the first partition overlaps the spacer.

### CROSS REFERENCE OF RELATED APPLICATION

The present application claims the priority to Chinese Patent Application No. 202610322455.8, titled “DISPLAY MODULE AND DISPLAY DEVICE”, filed on Mar. 16, 2026 with the China National Intellectual Property Administration (CNIPA), which is incorporated herein by reference in its entirety.

### FIELD

The present disclosure relates to the field of display technology, and in particular, to a display module and a display device.

### BACKGROUND

With the development of display technology, users'functional requirements for display devices are becoming increasingly diversified. In recent years, display devices having a wide/narrow viewing angle switching function have attracted widespread attention. Some existing technologies achieve the wide/narrow viewing angle switching function by designing an electrophoresis cell, but the existing design solutions for electrophoresis cells have disadvantages such as an excessively large bezel width that needs to be solved urgently.

### SUMMARY

The present disclosure provides a display module and a display device.

According to one aspect of the present disclosure, a display module is provided, including a display structure and a viewing angle adjustment structure disposed at a light-exiting side of the display structure;
the display module includes a display area and a non-display area at least partially surrounding the display area;
the viewing angle adjustment structure includes an electrophoretic liquid layer and a first substrate disposed at a side of the electrophoretic liquid layer away from the display structure; the electrophoretic liquid layer includes a plurality of electrophoretic particles, and the electrophoretic liquid layer is provided with partitions; the partitions include a first partition disposed in the non-display area and a second partition disposed in the display area;
the display module further includes a sealant structure disposed in the non-display area; the sealant structure includes a spacer, the sealant structure includes an opening, and the first partition is disposed in the opening; and,
in a direction perpendicular to a plane where the display module is located, the first partition overlaps the spacer.

According to another aspect of the present disclosure, a display device is provided, including a display module. The display module includes a display structure and a viewing angle adjustment structure disposed at a light-exiting side of the display structure;
the display module includes a display area and a non-display area at least partially surrounding the display area;
the viewing angle adjustment structure includes an electrophoretic liquid layer and a first substrate disposed at a side of the electrophoretic liquid layer away from the display structure; the electrophoretic liquid layer includes a plurality of electrophoretic particles, and the electrophoretic liquid layer is provided with partitions; the partitions include a first partition disposed in the non-display area and a second partition disposed in the display area;
the display module further includes a sealant structure disposed in the non-display area; the sealant structure includes a spacer, the sealant structure includes an opening, and the first partition is disposed in the opening; and,
in a direction perpendicular to a plane where the display module is located, the first partition overlaps the spacer.

The content described in this section is not intended to identify the key or important features of the embodiments of the present disclosure, nor is it intended to limit the scope of the present disclosure. Other features of the present disclosure will become easily understood through the following description.

### BRIEF DESCRIPTION OF THE DRAWINGS

To more clearly illustrate the embodiments of the present disclosure, the drawings for use in the description of the embodiments will be briefly introduced below. In one embodiment, the drawings described below are only some embodiments of the present disclosure.

FIG. 1 is a schematic structural diagram of an existing display module;

FIG. 2 is a schematic top view of a display module provided by an embodiment of the present disclosure;

FIG. 3 is a schematic cross-sectional view of a display module taken along BB′ in FIG. 2;

FIG. 4 is a schematic cross-sectional view of another display module taken along BB′ in FIG. 2;

FIG. 5 is a schematic cross-sectional view of yet another display module taken along BB′ in FIG. 2;

FIG. 6 is an enlarged schematic diagram of area Q in FIG. 5;

FIG. 7 is another enlarged schematic diagram of area Q in FIG. 5;

FIG. 8 is a schematic cross-sectional view of yet another display module taken along BB′ in FIG. 2;

FIG. 9 is an enlarged schematic structural diagram of area S in FIG. 2;

FIG. 10 is a schematic top view of another display module provided by an embodiment of the present disclosure;

FIG. 11 is a schematic top view of yet another display module provided by an embodiment of the present disclosure;

FIG. 12 is a schematic cross-sectional view of the display module taken along CC′ in FIG. 11;

FIG. 13 is a schematic cross-sectional view of the display module taken along JJ′ in FIG. 2;

FIG. 14 is another schematic cross-sectional view taken along BB′ in FIG. 2; and

FIG. 15 is a schematic structural diagram of a display device provided by an embodiment of the present disclosure.

### DETAILED DESCRIPTION OF THE EMBODIMENTS

To enable better understanding of the solutions of the present disclosure, the embodiments of the present disclosure will be clearly and completely described below in conjunction with the accompanying drawings of the embodiments of the present disclosure. In one embodiment, the described embodiments are only some of the embodiments of the present disclosure, rather than all the embodiments.

Without departing from the spirit or scope of the present disclosure, various modifications and changes can be made in the present disclosure, which is obvious to those skilled in the art. Therefore, the present disclosure is intended to cover the modifications and changes of the present disclosure that fall within the scope of the claims (the technical solution claimed for protection) and their equivalents. It should be noted that the implementations provided in the embodiments of the present disclosure can be combined with each other if there is no contradiction.

First of all, it should be noted that, unless otherwise defined, the technical terms or scientific terms used in the present disclosure shall have the usual meanings commonly understood by those with general skills in the field to which the present disclosure belongs. The words “first”, “second” and similar words used in the present disclosure do not indicate any order, quantity or importance, but are only used to distinguish different components. “include” and similar words mean that the element or object appearing before the word covers the elements or objects listed after the word and their equivalents, without excluding other elements or objects. “connect” or “connected” and similar words are not limited to physical or mechanical connections, but may include electrical connections, whether direct or indirect. “up”, “down”, “left” and “right” and similar terms are only used to indicate relative positional relationships. When the absolute position of the described object changes, the relative positional relationship may also change accordingly. In addition, the shapes and sizes of the components in the drawings do not reflect the actual proportions, and the purpose is only to schematically illustrate the content of the present disclosure.

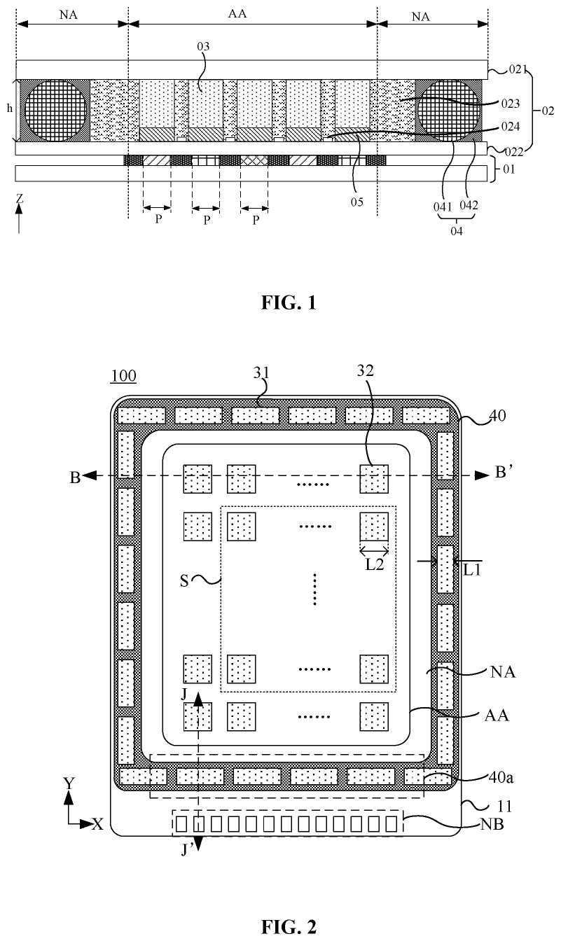

FIG. 1 is a schematic structural diagram of an existing display module. As shown in FIG. 1, in order to realize the wide/narrow viewing angle switching function, the existing display module is provided with an electrophoresis cell 02 above a display panel 01. The electrophoresis cell 02 includes an upper substrate 021, a lower substrate 022, an electrophoretic liquid 023 disposed between the upper substrate 021 and the lower substrate 022 and partitioned by partition walls 03, and control electrodes 024. In addition, a sealing structure 04 is further provided between the upper substrate 021 and the lower substrate 022, serving as a peripheral wall of the electrophoretic liquid 023 and playing a role of sealing the electrophoresis cell 02. The partition walls 023 are provided corresponding to the areas where sub-pixels P in the display panel 01 are disposed, and are light-transmitting structures. The electrophoretic liquid 023 is a mixture of a light-transmitting and fluid dispersion medium (solvent) and electrophoretic particles having light-shielding property and carrying charges of a specific polarity (either positive or negative charges). Due to the fluidity of the dispersion medium, the electrophoretic particles can move in the electrophoretic liquid. By adjusting the potential of the control electrode 024, wide/narrow viewing angle switching can be realized.

As shown in FIG. 1, to ensure that the sealing structure 04 provides sufficient support to the upper and lower substrates and ensure the structural stability of the electrophoresis cell 02, a hard structure 041 (e.g., silicon ball) is usually incorporated into a sealant material 042 to form the sealing structure 04. However, to ensure the narrow viewing angle display effect, the upper substrate 021 and the lower substrate 022 are typically spaced by a certain spacing (referred to as cell spacing, marked as h, the same below), so that the size of the hard structure 041 must be comparable to the cell spacing h to ensure the supporting, resulting in a large bazel width which is not conducive to the narrow bazel design. For example, in the conventional approach where silicon balls are incorporated into the sealant material to support the upper and lower substrates, a large-diameter nozzle is required to dispense the sealant material containing the large-sized silicon balls onto the lower substrate 022. This results in a large width of the sealing structure 04, increasing the bazel width and being detrimental to a narrow bazel design.

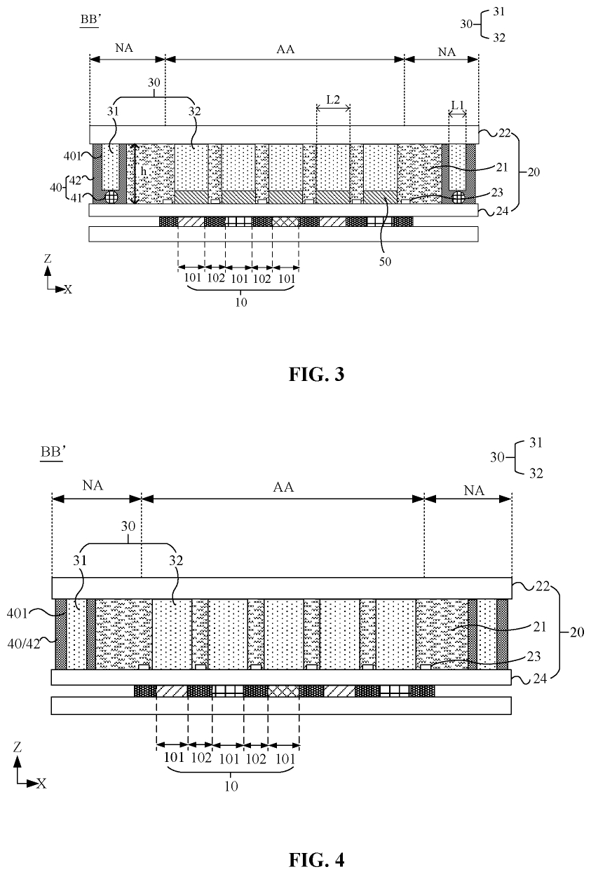

To solve this problem, an embodiment of the present disclosure provides a display module and a display device. FIG. 2 is a schematic top view of a display module provided by an embodiment of the present disclosure, and FIG. 3 is a schematic cross-sectional view of a display module taken along BB′ in FIG. 2. As shown in FIG. 2 and FIG. 3, the display module 100 provided by the embodiment of the present disclosure includes a display structure 10 and a viewing angle adjustment structure 20 disposed at a light-exiting side of the display structure 10; the display module 100 includes a display area AA and a non-display area NA at least partially surrounding the display area AA; the viewing angle adjustment structure 20 includes an electrophoretic liquid layer 21 and a first substrate 22 disposed at a side of the electrophoretic liquid layer 21 away from the display structure 10; the electrophoretic liquid layer 21 includes a plurality of electrophoretic particles, and the electrophoretic liquid layer 21 is provided with partitions 30; the partitions 30 include a first partition 31 disposed in the non-display area NA and a second partition 32 disposed in the display area AA; the display module 100 further includes a sealant structure 40 disposed in the non-display area NA; the sealant structure 40 includes an opening 401, and the first partition 31 is disposed in the opening 401.

The display structure 10 is used for display. As shown in FIG. 3, the display area AA of the display structure 10 includes pixel areas 101 and a non-pixel area 102. The pixel areas 101 are provided with sub-pixels for emitting light to realize display. The present disclosure does not limit the type of the display structure 10. The display structure can be an active light-emitting display structure, such as an OLED display structure, a micro-LED display structure, and a mini-LED display structure, etc., or can be a non-active light-emitting display structure, such as a liquid crystal display structure.

The viewing angle adjustment structure 20 (electrophoresis cell) is disposed at the light-exiting side of the display structure 10, for adjusting the light-exiting angle of the display module 100, so that the display module 100 can switch between wide and narrow viewing angles. As shown in FIG. 3, the viewing angle adjustment structure 20 includes a first substrate 22, a second substrate 24, an electrophoretic liquid layer 21 and a first electrode 23 disposed between the first substrate 22 and the second substrate 24. The electrophoretic liquid layer 21 is provided with partitions 30. The partitions 30 include a second partition 32 disposed in the display area AA for partitioning the electrophoretic liquid. The partition 30 is a light-transmitting structure. Along the direction Z perpendicular to the plane where the display module is located, the second partition 32 overlaps the pixel area 101, and the electrophoretic liquid in the electrophoretic liquid layer 21 overlaps the non-pixel area 102; the first electrode 23 is disposed at a side of the electrophoretic liquid layer 21 close to the display structure 10. In the direction Z perpendicular to the plane where the display module is located, the first electrode 23 does not overlap the second partition 32 (the first electrode 23 overlaps the non-pixel area 102). In this way, by controlling the voltage of the first electrode 23, the state of the electrophoretic particles in the electrophoretic liquid (uniformly dispersed or gathered near the first electrode 23) can be controlled, thereby realizing wide/narrow viewing angle switching (described in detail below in conjunction with the drawings).

That the electrophoretic liquid layer 21 is provided with the partitions 30 can be specifically understood as that the partitions 30 are disposed within the hierarchical range where the electrophoretic liquid layer 21 is disposed (the range from the bottom of the electrophoretic liquid to the top of the electrophoretic liquid). Referring to FIG. 3, the electrophoretic liquid layer 21 is disposed between the first substrate 22 and the second substrate 24, therefore, the partitions 30 are also disposed between the first substrate 22 and the second substrate 24.

Further, as shown in FIG. 3, in this embodiment, in addition to the second partition 32 disposed in the display area AA, the partitions 30 further include a first partition 31 disposed in the non-display area NA.

Specifically, in this embodiment, the first partition 31 and the second partition 32 are prepared in the same process. According to the explanation above, the partition 30 is a light-transmitting structure. Exemplarily, the first partition 31 disposed in the non-display area NA and the second partition 32 disposed in the display area AA can be formed in the same photolithography process using a transparent photoresist.

It should be noted that the partitions 30 can be formed on the first substrate 22 or on the second substrate 24, and the present disclosure does not limit this. Forming the partitions 30 on the first substrate 22 has a simpler process and higher controllability. The following description only takes the case where the partitions 30 are formed on the first substrate 22 as an example for illustration.

Further, the first partition 31 is disposed in the opening 401 of the sealant structure 40. Specifically, along the direction Z perpendicular to the plane where the display module is located, and along the direction parallel to the plane where the display module is located, the first partition 31 overlaps the opening 401. The first partition 31 is disposed in the accommodating space of the opening 401 of the sealant structure 40, and contacts the sealant structure 40 via the opening 401.

As shown in FIG. 3, the sealant structure 40 includes a sealant 42. It should be noted that, in this embodiment, the opening 401 is not deliberately formed on the sealant structure 40. Rather, during sealing process of the upper substrate 22 and the lower substrate 24, the first partition 31 is embedded into the uncured sealant 42, and after curing, the resulting product structure of the display module exhibits that the sealant structure 40 naturally defines the opening 401 in which the first partition 31 is disposed. It can be understood that the volume of the first partition 31 is equal to the volume of the opening 401. Exemplarily, taking the case where the partitions 30 are formed on the first substrate 22 as an example, the manufacturing process of the electrophoresis cell is as follows: after forming the first electrode 23 on the second substrate 24, the sealant 42 is first coated on the bazel area of the second substrate 24; then the electrophoretic liquid is injected into the area enclosed by the sealant 42; subsequently the upper substrate 22 formed with the first partition 31 and the second partition 32 is pressed down onto the second substrate 24, so that the second partition 32 partitions the electrophoretic liquid, and the first partition 31 is inserted into the sealant 42; and finally, the sealant 42 is cured to form the sealant structure 40. The resulting product structure of the display module exhibits that the sealant structure 40 has the opening 401, and the first partition 31 is disposed in the opening 401.

In this embodiment, by providing the partitions 30 that include the first partition 31 and the second partition 32, that is, forming the first partition 31 in the non-display area NA while forming the second partition 32 in the display area AA, and by disposing the first partition 31 in the opening 401 of the sealant structure 40, it is beneficial to reducing the bazel width (the width of the non-display area NA along the direction pointing from the display area AA to the non-display area NA).

Referring to FIG. 3, in an embodiment, optionally, the height of the partition 30 is smaller than the cell spacing h. In addition to the sealant 42, the sealant structure 40 further includes a spacer 41. In the direction Z perpendicular to the plane where the display module is located, the first partition 31 overlaps the spacer 41.

Specifically, when the height of the partition 30 is smaller than the cell spacing h, the sealant 42 contains the spacer 41. In this way, after the first substrate 22 is pressed down so that the first partition 31 is inserted into the sealant 42, the first partition 31 will squeeze the spacer 41, so that the first partition 31 and the spacer 41 overlap in the direction Z perpendicular to the plane where the display module is located. The first partition 31 and the spacer 41 jointly play a role of supporting the first substrate 22 and the second substrate 24, ensuring the structural stability of the viewing angle adjustment structure 20. In this embodiment, through the design of the first partition 31, the size of the spacer 41 can be greatly reduced (smaller than the cell spacing h), so that the size of the nozzle for dispensing the sealant 42 containing the spacer 41 can be reduced, thereby reducing the width of the sealant structure 40 in the direction pointing from the display area AA to the non-display area NA, i.e., reducing the bazel width. It should be noted that the width of the first partition 31 is independent of its height and can be adjusted as needed.

Optionally, the spacer 41 is spherical, for example, a silicon ball. In this way, it is convenient to dispense the sealant containing the spacer 41. Exemplarily, in this embodiment, the diameter of the spacer 41 (silicon ball) is 5 μm~20 μm.

Exemplarily, when the height of the partition 30 is smaller than the cell spacing h, a supporting column 50 is optionally provided at a side of the second substrate 24 close to the second partition 32. Along the direction Z perpendicular to the plane where the display module is located, the supporting column 50 overlaps the second partition 32. In the display area AA, the second partition 32 and the supporting column 50 jointly support the first substrate 22 and the second substrate 24 and partition the electrophoretic liquid. Exemplarily, the supporting column 50 can be formed on the second substrate 24, and its material is the same as that of the partition 30.

In other embodiments, FIG. 4 is a schematic cross-sectional view of another display module taken along BB′ in FIG. 2. Referring to FIG. 4, optionally, the height of the partition 30 is equal to the cell spacing h. In this case, no other structure needs to be incorporated into the sealant structure 40 (only including the sealant 42). In the non-display area NA, the first partition 31 supports the first substrate 22 and the second substrate 24, thereby the bazel width can be reduced by reducing the width of the first partition 31.

In the following, the technical solutions of the embodiments of the present disclosure are described by taking the case where the height of the partition 30 is smaller than the cell spacing h, the sealant structure 40 includes the spacer 41, and the first partition 31 overlaps the spacer 41 in the direction Z perpendicular to the plane where the display module is located as an example.

In summary, in the embodiments of the present disclosure, by providing the viewing angle adjustment structure at the light-exiting side of the display structure, the function of wide/narrow viewing angle switching can be realized. Furthermore, by providing partitions that include not only the second partition disposed in the display area for partitioning the electrophoretic liquid but also the first partition disposed in the non-display area, and by providing that the first partition is disposed in the opening of the sealant structure and overlaps the spacer in the sealant structure along the direction perpendicular to the plane where the display module is located, the first partition and the spacer can play a supporting role in the bazel area, which is beneficial to reducing the size of the spacer, thereby reducing the width of the sealant structure, reducing the bazel width, and realizing a narrow bazel.

Referring to FIG. 4, it should be noted that the second substrate 24 may be a separate substrate provided for the viewing angle adjustment structure 20, or a layer structure of the display structure 10 may be reused as the second substrate 24. Exemplarily, an upper cover plate of the display structure 10 may be reused as the second substrate 24, which is beneficial to reducing the thickness of the display module. In other embodiments, other structures in the display structure 10 may be reused as the second substrate 24, and the embodiment of the present disclosure is not limited thereto.

The technical solution of the embodiment of the present disclosure is further described below by taking the case where the display structure 10 is an OLED display structure as an example. Other types of display structures may be designed with reference to the following schemes, which will not be illustrated one by one here, provided that no conflicts arises.

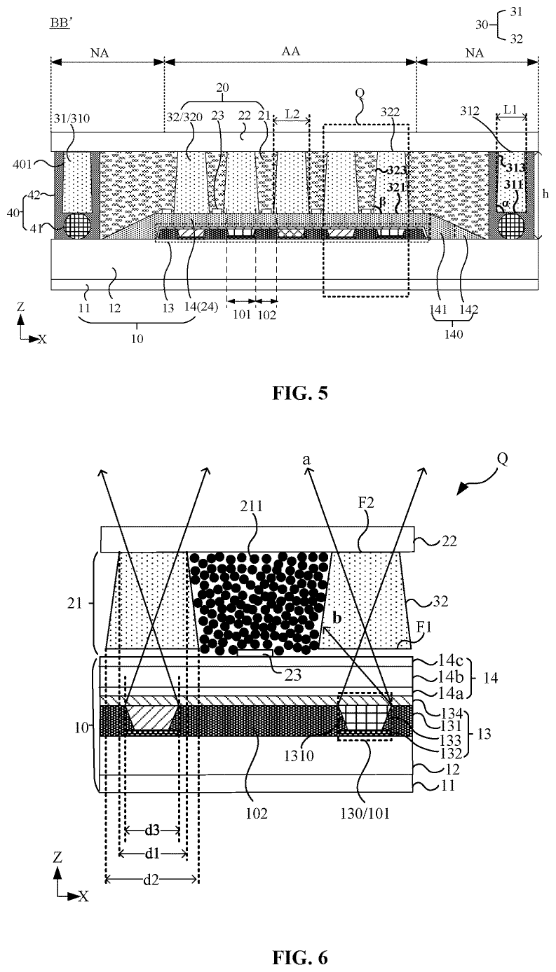

Exemplarily, FIG. 5 is a schematic cross-sectional view of another display module taken along BB′ in FIG. 2. As shown in FIG. 5, optionally, the display structure 10 includes a base substrate 11 and a thin film encapsulation layer 14 disposed between the base substrate 11 and the electrophoretic liquid layer 21; the thin film encapsulation layer 14 has a slope structure 140 in the non-display area NA; the slope structure 140 includes a first slope sub-portion 141 and a second slope sub-portion 142, the second slope sub-portion 142 is disposed at a side of the first slope sub-portion 141 away from the display area AA; in the direction Z perpendicular to the plane where the base substrate 11 is located, a thickness of the first slope sub-portion 141 is larger than a thickness of the second slope sub-portion 142.

The base substrate 11 can be used to block oxygen and moisture, preventing moisture or impurities from diffusing through the base substrate 11. A flat surface may be formed on an upper surface of the base substrate 11. The base substrate 11 can be flexible (corresponding to forming a flexible display structure) or rigid (corresponding to forming a rigid display structure), and the present disclosure does not limit this.

As shown in FIG. 5, in the case that the display structure 10 is an OLED display structure, the display structure 10 further includes an array layer 12 and a light-emitting layer 13 disposed between the base substrate 11 and the thin film encapsulation layer 14. The light-emitting layer 13 is disposed at a side of the array layer 12 away from the base substrate 11 and is covered by the thin film encapsulation layer 14.

The array layer 12 may comprise various functional circuits, such as a pixel circuit disposed in the display area AA and circuit structures such as a scan driving circuit, a multiplexing circuit, and an electrostatic protection circuit disposed in the non-display area. The present disclosure does not limit this, and those skilled in the art can design the layer structure of the array layer as required.

The light-emitting layer 13 includes a plurality of light-emitting elements (OLED elements), and the areas where the light-emitting elements are disposed are the pixel areas 101. Exemplarily, FIG. 6 is an enlarged schematic diagram of area Q in FIG. 5. As shown in FIG. 6, the light-emitting layer 13 includes a pixel defining layer 131. The pixel defining layer 131 is provided with pixel openings 1310. The pixel opening 1310 exposes an anode 132 of a light-emitting element 130. A light-emitting functional layer 133 of the light-emitting element 130 is disposed in the pixel opening 1310. A cathode 134 of the light-emitting element 130 is disposed at a side of the light-emitting functional layer 133 away from the anode 132. The anode 132 of the light-emitting element 130 is electrically connected to the pixel circuit in the array layer 12 (not shown), and the light-emitting element is driven by the pixel circuit to emit light. Optionally, the light-emitting layer 13 at least includes light-emitting elements of two different light-emitting colors, to realize color display.

The thin film encapsulation layer 14 is formed by stacking organic layer(s) and inorganic layer(s), for preventing water and oxygen from corroding the light-emitting elements. Referring to FIG. 6, optionally, the thin film encapsulation layer 14 includes a first inorganic layer 14a, a first organic layer 14b, and a second inorganic layer 14c. The first organic layer 14b is disposed between the first inorganic layer 14a and the second inorganic layer 14c.

Referring to FIG. 5, during the forming of the thin film encapsulation layer 14 on the side of the light-emitting layer 13 away from the array layer 12, vapor deposition processes such as atomic layer deposition and magnetron sputtering are usually adopted. Due to the directivity limitation of vapor deposition and the need for the deposition process to cover the steps formed by the light-emitting layer 13 and the array layer 12 below, the thin film encapsulation layer 14 forms a slope structure 140 in the non-display area NA, i.e., forming a slope with an inclined transition.

As shown in FIG. 5, the slope structure 140 includes a first slope sub-portion 141 and a second slope sub-portion 142. The second slope sub-portion 142 is disposed at a side of the first slope sub-portion 141 away from the display area AA. In the direction Z perpendicular to the plane where the base substrate 11 is located, a thickness of the first slope sub-portion 141 is larger than a thickness of the second slope sub-portion 142. The thickness of the first slope sub-portion 141 can be understood as the overall thickness of the first slope sub-portion 141, and the thickness of the second slope sub-portion 142 can be understood as the overall thickness of the second slope sub-portion. In an overall view, the thickness of the first slope sub-portion 141 is larger than the thickness of the second slope sub-portion 142. In general, the thickness of the slope structure 140 gradually decreases along the direction pointing from the display area AA to the non-display area NA.

As shown in FIG. 5, optionally, the thin film encapsulation layer 14 is reused as the second substrate 24 of the viewing angle adjustment structure 20. In this case, the electrophoretic liquid layer 21 is disposed between the first substrate 22 and the thin film encapsulation layer 14, and the first electrode 23 is disposed on the thin film encapsulation layer 14 (the first electrode 23 is in contact with the thin film encapsulation layer 14). Such arrangement is beneficial to reducing the distance between the second partition 32 and the light-emitting elements, reducing the alignment difficulty and also reducing the thickness of the display module.

As shown in FIG. 5, if the thin film encapsulation layer 14 is reused as the second substrate 24 of the viewing angle adjustment structure 20, in the non-display area NA, the cell spacing h is the distance between the lower surface of the first substrate 22 and the part of the upper surface of the array layer 12 not covered by the thin film encapsulation layer 14. The cell spacing h is larger than the height of the second partition 32. Based on this design, it is found that for the existing solution of incorporating large silicon balls comparable to the cell spacing h into the sealant 42 to support the first substrate 22 and the array layer 12, on the one hand, it will cause a large bazel width due to the large size of the silicon balls; on the other hand, after the sealant containing the large silicon balls is dispensed onto the array layer 12 in the non-display area NA, the silicon balls may roll to locations above the slope structure 140 of the thin film encapsulation layer 14 due to the rolling property and get stuck between the slope structure 140 and the first substrate 22, affecting the cell assembly. For example, problems such as the thickness of the electrophoresis cell exceeding expectations, unevenness of the electrophoresis cell, and the distance between the second partition 32 and the second substrate 22/thin film encapsulation layer 14 exceeding expectations, may occur, resulting in inability to partition the electrophoretic liquid.

In this regard, referring to FIG. 5 and the explanation above, the technical solution of the embodiment of the present disclosure is proposed, where the first partition 31 is formed in the non-display area NA while forming the second partition 32 in the display area AA. By providing the first partition 31 that is disposed in the opening 401 of the sealant structure 40 and overlaps the spacer 41 (e.g., silicon ball) in the direction Z perpendicular to the plane where the display module is located, the first partition 31 and the spacer 41 can jointly play a supporting role, greatly reducing the size of the spacer 41 and reducing the bazel width. Moreover, because the size of the spacer 41 is small, even if the spacer 41 moves to above the slope structure 140 of the thin film encapsulation layer 14, it has sufficient space to move and is less likely to get stuck on the slope structure 140. Thus the problem of poor cell assembly is alleviated and the product yield is improved.

As shown in FIG. 5, optionally, in the direction Z perpendicular to the plane where the base substrate 11 is located, the first partition 31 does not overlap the slope structure 14. Such arrangement avoids the sealant structure 40 overlapping the slope structure 140, further reducing the risk of the spacer 41 moving to above the slope structure 140, and further ensuring the structural stability of the electrophoresis cell and the cell assembly yield.

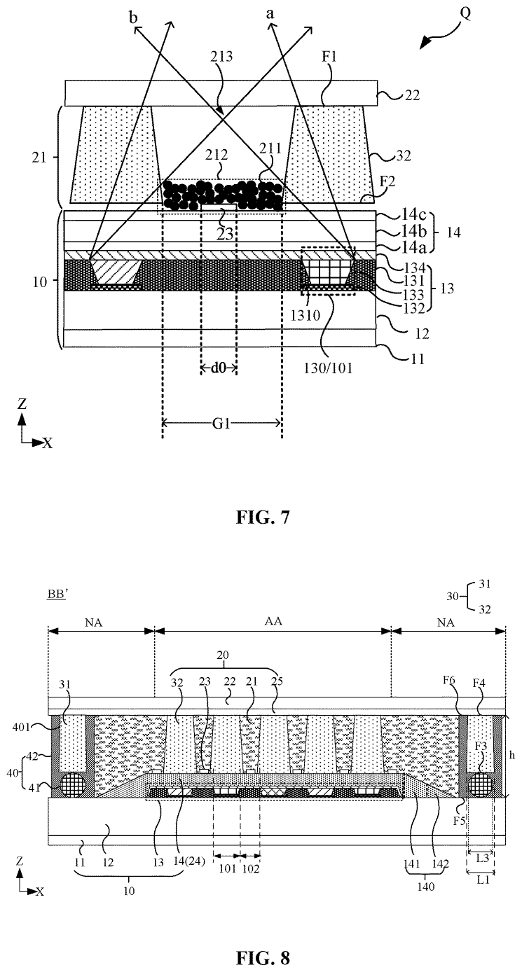

Referring to FIG. 6, FIG. 6 shows the state of the electrophoretic particles in the narrow viewing angle mode (the solvent is not shown). FIG. 7 is another enlarged schematic diagram of area Q in FIG. 5, showing the state of the electrophoretic particles in the wide viewing angle mode (the solvent is not shown). With reference to FIG. 6 and FIG. 7, the viewing angle adjustment principle of the viewing angle adjustment structure is as follows: the electrophoretic particles 211 have a first state (FIG. 7) and a second state (FIG. 6) in the electrophoretic liquid of the electrophoretic liquid layer; as shown in FIG. 7, in the first state, the first electrode 23 attracts the electrophoretic particles 211, and the electrophoretic particles 211 gather in a first region 212 of the electrophoretic liquid; the electrophoretic liquid further includes a second region 213, and the first region 212 is at a side of the second region 213 close to the display structure 10; as shown in FIG. 6, in the second state, the electrophoretic particles 211 are freely distributed in the electrophoretic liquid; the viewing angle of the display module when the electrophoretic particles are in the first state is larger than the viewing angle of the display module when the electrophoretic particles are in the second state.

Specifically, when the electrophoretic particles are in the first state (FIG. 7), the display module is in a wide viewing angle display mode (non-privacy mode/sharing mode); when the electrophoretic particles are in the second state (FIG. 6), the display module is in a narrow viewing angle display mode (privacy mode).

As shown in FIG. 7, when the electrophoretic particles are in the first state, that is, the electrophoretic particles 211, under the attraction of the first electrode 23, gather in the first region 212 of the electrophoretic liquid closer to the display structure 10, a first part of light a (referring to small-angle light) emitted from the pixel area 101 passes through the second partition 32, and a second part of light b (referring to large-angle light) emitted from the pixel area 101 passes through the second partition 32 and the second region 213, so that the display module has a relatively large view angle when the electrophoretic particles are in the first state, realizing wide viewing angle display. It can be understood that the second region 213 is a blank area not including the electrophoretic particles 211, or in other words, the second region 213 only has the dispersion medium (solvent), having light-transmitting property.

Specifically, by applying a voltage with a polarity opposite to the charge carried by the electrophoretic particles 211 to the first electrode 23, the first electrode 23 can attract the electrophoretic particles 211. Exemplarily, the electrophoretic particles 211 can carry negative charges, and a positive voltage can be applied to the first electrode 23 to make the first electrode 23 attract the electrophoretic particles 211. Different voltages can be applied to the first electrode 23 according to actual needs to realize different viewing angles. In other embodiments, the electrophoretic particles 211 may alternatively carry positive charges, and a negative voltage is applied to the first electrode 23, which is not limited in the present disclosure.

As shown in FIG. 6, when the electrophoretic particles are in the second state, that is, the electrophoretic particles 211 are freely distributed in the electrophoretic liquid. Because the electrophoretic particles 211 have light-shielding property, the first part of light a (referring to small-angle light) emitted from the pixel area 101 passes through the second partition 32, while the second part of light b (referring to large-angle light) emitted from the pixel area 101 is blocked by the electrophoretic particles 211, so that the display module has a relatively small viewing angle when the electrophoretic particles are in the second state, realizing the privacy effect.

Optionally, a zero voltage can be applied to the first electrode 23 to ensure that the first electrode 23 does not attract the electrophoretic particles 211, so that the electrophoretic particles 221 are freely distributed in the electrophoretic liquid.

It should be noted that FIG. 6 and FIG. 7 only illustrate the case where there is a relatively narrow slit between the second partition 32 and the thin film encapsulation layer 14 as an example. The electrophoretic particles 211 have a certain viscosity, and the slit is relatively narrow, so it can be avoided as much as possible that the electrophoretic particles 211 diffuse into the slit and cause brightness loss. Exemplarily, the height of the slit is less than ⅕ of the height of the second partition.

In other embodiments, referring to FIG. 3, one or more supporting columns 50 can be provided in at least some of the pixel areas 101 on the thin film encapsulation layer 14, so that at least some of the second partitions 32 contact with the supporting column(s) 50. In the case where only some of the second partition 32 are correspondingly provided with the supporting column 50, the height of the supporting column is optionally less than ⅕ of the height of the second partitions 32. In this way, for the second partition 32 without a corresponding supporting column, the spacing between it and the thin film encapsulation layer 14 is small (i.e., there is a slit), which can avoid the electrophoretic particles diffusing into the slit and causing brightness loss as much as possible.

FIG. 8 is a schematic cross-sectional view of another display module taken along BB′ in FIG. 2. As shown in FIG. 8, in an embodiment, optionally, the viewing angle adjustment structure 20 further includes a common electrode 25; the common electrode 25 is disposed at a side of the first substrate 22 close to the electrophoretic liquid layer 21. In the direction Z perpendicular to the plane where the display module is located, the common electrode 25 at least overlaps the first electrode 23.

The common electrode 25 is designed as a transparent electrode, and a common voltage is applied to the common electrode. Such arrangement can make the electric field more stable when the first electrode 23 is applied with a voltage, thereby improving the working state stability in different display modes. Referring to FIG. 8, optionally, the common electrode 25 is provided as a continuous layer.

Regarding the design of the first electrode 23, referring to FIG. 7, optionally, in the first direction (such as the X direction), a spacing G1 between two adjacent second partitions 32 is larger than a width d0 of the first electrode 23; the first direction is the direction pointing from the display area AA to the non-display area NA. Such arrangement can reduce the space occupied by the first electrode 23 while ensuring the attraction effect of the first electrode 23, so that the electrophoretic particles 211 in the first state are as close to the display structure 10 as possible, thereby reducing the blocking of large viewing angle light by the electrophoretic particles 211 as much as possible, and increasing the viewing angle of the display module.

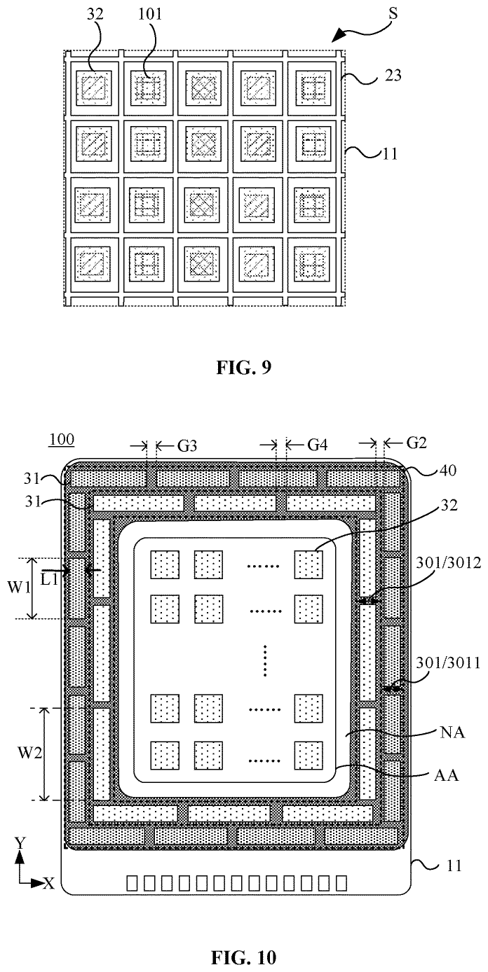

FIG. 9 is an enlarged schematic structural diagram of area S in FIG. 2. As shown in FIG. 9, optionally, the projection of the first electrode 23 on the base substrate 11 forms a mesh pattern, and the projections of the second partitions 32 and the pixel areas 101 on the base substrate 11 are both located in the openings of the mesh pattern. Referring to FIG. 5, the mesh lines of the mesh pattern (i.e., the body of the first electrode 23) overlap the non-pixel area 102. By designing the first electrode 23 in a mesh pattern, on the one hand, design conflict with the second partition 32 can be avoided; on the other hand, when the display module is in the privacy mode, the first electrodes 23 is supplied with voltage through one signal line, simplifying the design difficulty of the display module.

In other embodiments, independent first electrodes 23 can be designed according to actual needs. For example, in some application scenarios where local privacy protection is needed, a preset voltage can be applied only to the first electrodes in the privacy protection area to reduce power consumption. Exemplarily, each first electrode 23 can be in a mesh pattern.

In addition, in the case where the viewing angle adjustment structure 20 includes the common electrode, the common electrode can also be patterned in the same way as the first electrode 23, as long as it is ensured that the common electrode 25 overlaps the first electrode 23.

Referring to FIG. 9, optionally, an orthographic projection of the pixel area 101 on the base substrate 11 is within an orthographic projection range of the second partition 32 on the base substrate 11.

With reference to FIG. 6, specifically, the orthographic projection of the pixel area 101 on the base substrate 11 can be the maximum projection area of the pixel opening 1310 on the base substrate 11. Exemplarily, as shown in FIG. 6, along the direction pointing from the base substrate 11 to the first substrate 22, the opening area of the pixel opening 1310 gradually increases. The orthographic projection of the pixel area 101 on the base substrate 11 specifically refers to the orthographic projection of the upper opening of the pixel opening 1310 on the base substrate 11.

Continuing to refer to FIG. 6, specifically, the orthographic projection of the second partition 32 on the base substrate 11 may be the minimum projection area of the second partition 32 on the base substrate 11, i.e., the orthographic projection of the smaller one of the upper and lower surfaces of the second partition 32 on the base substrate 11. As shown in FIG. 6, in an embodiment, optionally, the second partition 32 includes a first surface F1 and a second surface F2. The first surface F1 is at a side of the second surface F2 away from the first substrate 22, and the area of the first surface F1 is larger than the area of the second surface F2. In this case, the orthographic projection of the second partition 32 on the base substrate 11 specifically refers to the orthographic projection of the second surface F2 with a smaller area on the base substrate 11. The orthographic projection of the second surface F2 on the display structure 10 covers the pixel area 101. In other words, the orthographic projection of the pixel area 101 on the base substrate 11 is within the orthographic projection range of the second surface F2 on the base substrate 11.

Viewed from the cross-sectional view shown in FIG. 6, the cross-section of the second partition 32 on the first section plane (the section plane shown in FIG. 6) is a regular trapezoid (narrow at the top and wide at the bottom): along the direction pointing from the display area AA to the non-display area NA, its upper base width is d1, and its lower base width is d2, d2>d1. The cross-section of the area where the pixel opening 1310 is located on the first section plane (the section plane shown in FIG. 6) is a virtual inverted trapezoid: along the direction pointing from the display area AA to the non-display area NA, its upper base width is d3 (i.e., the width of the pixel area 101 is d3). In this embodiment, by configuring that d2>d1>d3, it can be realized that the orthographic projection of the pixel area 101 on the base substrate 11 is within the orthographic projection range of the second partition 32 on the base substrate 11.

The applicant found through research that if the light channel of the second partition 32 is of the same size as the sub-pixel in the pixel area 101, it is prone to cause uneven angular distribution of the emitted light in the privacy mode. In the above implementation, by providing that the orthographic projection of the pixel area 101 on the base substrate 11 is within the orthographic projection range of the second partition 32 on the base substrate 11, the light channel formed by the second partition 32 can be made larger than the pixel area 101, thereby improving the display effect and avoiding uneven light emission in the privacy mode.

It should be noted that in FIG. 9, different pixel areas 101 with different filling patterns represent sub-pixels of different colors. The exemplary number, types, colors of the sub-pixels, the exemplary arrangement of sub-pixels of different colors, and the exemplary sizes shown in FIG. 9 are not limitations, and the technical solution of the embodiment of the present disclosure can be applicable to any type of pixel arrangement.

Referring to FIG. 6, in an embodiment, optionally, 1 μm≤d1−d3≤3 μm. Different pixel areas may have different sizes. For any pixel area, the size of the corresponding second partition 32 exceeds the size of the pixel area by 1 μm~3 μm. Such arrangement can avoid the second partition 32 occupying excessive space while improving the display effect, ensuring the movement space for the electrophoretic particles and ensuring the wide viewing angle display effect.

It should also be noted that FIG. 6 only illustrates the case where the cross-section of the second partition 32 on the first section plane (the section plane shown in FIG. 6) is a regular trapezoid (narrow at the top and wide at the bottom) as an example. Referring to FIG. 3, in other embodiments, the cross-section of the second partition 32 on the first section plane can be alternatively a rectangle. In this case, the first surface (lower surface) and the second surface (upper surface) of the second partition 32 have the same size, and their orthographic projections on the base substrate 11 overlap. Such a design can also ensure that the orthographic projection of the pixel area 101 on the base substrate 11 is within the orthographic projection range of the second partition 32 on the base substrate 11.

In the above, taking the OLED display structure as a basis, the structure and working principle of the viewing angle adjustment structure 20 and the arrangement of the second partition 32 are described in detail. Below, a further detailed description of the arrangement of the first partition 31 is provided.

Referring to FIG. 3 and FIG. 5, optionally, along the first direction (such as the X direction), a maximum width L1 of the first partition 31 is smaller than a maximum width L2 of the second partition 32; the first direction is the direction pointing from the display area AA to the non-display area NA.

Referring to FIG. 2, FIG. 3 and FIG. 5, the first partition 31 is disposed in the opening 401 of the sealant structure 40. In this embodiment, by providing that the maximum width L1 of the first partition 31 is smaller than the maximum width L2 of the second partition 32, it is beneficial to reducing the width of the sealant structure 40, thereby reducing the bazel width.

It should be noted that the first direction refers to a direction parallel to the plane where the first substrate 22 is located and pointing from the display area AA to the non-display area NA. Referring to FIG. 2, the first direction varies for different areas. For example, for the left and right bazels, the first direction refers to the X direction in the figure; for the upper and lower bazels, the first direction refers to the Y direction in the figure. Further, taking the first direction being the X direction as an example, referring to FIG. 2 and FIG. 3, the maximum width of the partition 30 in the first direction (X direction) specifically refers to the length of the longer of the upper and lower sides in the cross-section of the partition 30.

Exemplarily, FIG. 3 illustrates the case where the cross-section of the partitions 30 (the first partition 31 and the second partition 32) on the first section plane (the section plane shown in FIG. 3) is a rectangle as an example. In this case, the lengths of the upper side and the lower side of the cross-section of the partition 30 are equal, both being the maximum width of the partition.

Exemplarily, FIG. 5 illustrates the case where the cross-section of the partitions 30 (the first partition 31 and the second partition 32) on the first section plane (the section plane shown in FIG. 5) is a trapezoid as an example. In this case, the maximum width of the partition 30 in the first direction specifically refers to the length of the longer of the upper and lower sides in the trapezoid. FIG. 5 illustrates the case where the upper side length of the cross-section (trapezoid) of the partition 30 is smaller than the lower side length as an example. In this case, the maximum width L1 of the first partition 31 in the first direction refers to the length of the lower side of the cross-section (trapezoid) of the first partition 31. Similarly, the maximum width L2 of the second partition 32 in the first direction refers to the length of the lower side of the cross-section (trapezoid) of the second partition 32.

Referring to FIG. 5, optionally, in the direction Z perpendicular to the plane where the display module is located, the height of the first partition 31 is equal to the height of the second partition 32. Specifically, because the first partition 31 and the second partition 32 are prepared in the same process, their heights are equal. To ensure the privacy display effect, the second partition 32 in the display area AA usually needs to have a relatively high height. Therefore, in the present disclosure, the first partition 31 with a relatively high height is obtained in the non-display area NA while forming the second partition 32, which can greatly reduce the height of the spacer 41, thereby reducing the bazel width and ensuring the cell assembly yield.

Referring to FIG. 5, the cross-section of the first partition 31 on the first section plane (the section plane shown in FIG. 5) is a first trapezoid 310, and the cross-section of the second partition 32 on the first section plane is a second trapezoid 320; the first section plane is perpendicular to the plane where the display module is located; the first trapezoid 310 has a first side 311, a second side 312 and a first lateral side 313 connecting the first side 311 and the second side 312, with the first side 311 being farther from the first substrate 22 than the second side 312. The second trapezoid 320 has a third side 321, a fourth side 322 and a second lateral side 323 connecting the third side 321 and the fourth side 322, with the third side 321 being farther from the first substrate 22 than the fourth side 322. An included angle between the first side 311 and the first lateral side 313 is α, an included angle between the third side 321 and the second lateral side 323 is β, and β<α≤90°.

Specifically, for the second partition 32 in the display area AA, by providing that the cross-section of the second partition 32 on the first section plane is the second trapezoid 320 narrow at the top and wide at the bottom, it is beneficial to dispersing pressure, reducing the deformation of the electrophoresis cell caused by external impact, improving the structural stability and impact resistance of the electrophoresis cell, and also beneficial to reducing the risk of the second partition 32 tipping over during assembly or use, ensuring the consistency of the internal spacing of the electrophoresis cell, and ensuring the stability of the display effect.

For the first partition 31 in the non-display area NA, by providing that the cross-section of the first partition 31 on the first section plane is the first trapezoid 310 narrow at the top and wide at the bottom, it is beneficial to increasing the contact area between the first partition 31 and the spacer 41, ensuring the stable support of the sealant structure 40 to the electrophoresis cell.

The included angle between the first side 311 and the first lateral side 313 is the inclination angle of the sidewall of the first partition 31, and the included angle between the third side 321 and the second lateral side 323 is the inclination angle of the sidewall of the second partition 32. In this embodiment, by providing that the inclination angle (α) of the sidewall of the first partition 31 is larger than the inclination angle (β) of the sidewall of the second partition 32, the included angle α is closer to 90° than the included angle β, so that the first partition 31 is closer to a straight columnar shape. Such arrangement can make the thickness variation of the first partition 31 at different positions smaller. When pressing down the first substrate 22 so that the first partition 31 contacts and squeezes the spacer 41, it is beneficial to ensuring the structural stability of the first partition 31, avoiding damage during squeezing due to the edge area being too thin caused by a too small inclination angle (α).

Referring to FIG. 8, optionally, the display structure 10 includes a base substrate 11, the first partition 31 includes a third surface F3 and a fourth surface F4, the fourth surface F4 is disposed at a side of the third surface F3 away from the base substrate 11; the sealant structure 40 includes a fifth surface F5 and a sixth surface F6, the sixth surface F6 is disposed at a side of the fifth surface F5 away from the base substrate 11; in the direction Z perpendicular to the plane where the base substrate 11 is located, a distance between the fourth surface F4 and the base substrate 11 is equal to a distance between the sixth surface F6 and the base substrate 11. In other words, in the direction Z perpendicular to the plane where the base substrate 11 is located, the fourth surface F4 and the sixth surface F6 are flush. In this case, the spacer 41 is disposed at a side of the first partition 31 away from the first substrate 22.

Specifically, from the perspective of the process flow, in this embodiment, the partition 30 is formed on the first substrate 22. After the sealant containing the spacer 41 is coated on the non-display area NA, and the electrophoretic liquid is injected into the area enclosed by the sealant, the first substrate 22 formed with the first partition 31 and the second partition 32 is pressed down onto the display structure 10. In this way, the first partition 31 will be inserted into the sealant 42, squeezing the spacer 41 to position below the first partition 31. The sealant 42 enclose the bottom surface and sidewalls of the first partition 31, and the upper surface (sixth surface F6) of the sealant 42 is flush with the upper surface (fourth surface F4) of the first partition 31.

In this embodiment, by forming the partition 30 on the first substrate 22, it is beneficial to ensuring the height consistency of the first partition 31 and the second partition 32, ensuring the height controllability of the first partition 31 and the second partition 32, and improving the product yield. In other embodiments, the first partition 31 can alternatively be formed on the lower substrate of the electrophoresis cell, for example, directly formed on the display structure 10, which is not limited in the embodiment of the present disclosure.

Referring to FIG. 8, optionally, along the first direction (such as the X direction), the maximum width L1 of the first partition 31 is larger than a maximum width L3 of the spacer 41; the first direction is the direction pointing from the display area AA to the non-display area NA.

The maximum width of the spacer 41 in the first direction refers to the maximum of the widths, at different heights, of the cross-section of the spacer 41 taken in the first section plane. Exemplarily, when the spacer 41 is spherical, the maximum width of the spacer 41 in the first direction refers to the diameter of the spacer 41.

In this embodiment, by providing that the maximum width L1 of the first partition 31 in the first direction is larger than the maximum width L3 of the spacer 41 in the first direction, it is beneficial to ensuring that the first partition 31 properly covers the spacer 41, thereby ensuring the supporting effect of both the first partition 31 and the spacer 41, and thus ensuring the structural stability of the electrophoresis cell, and improving the product yield.

Referring to FIG. 8, in the direction Z perpendicular to the plane where the display module is located, the height of the first partition 31 is larger than the height of the spacer 41.

In this embodiment, the height of the first partition 31 is substantially equal to the height of the second partition 32. To ensure the narrow viewing angle display effect, the second partition 32 has a relatively high height. In turn the height of the first partition 31 is also relatively high, usually accounting for more than half of the cell spacing h. Therefore, the height of the first partition 31 is larger than the height of the spacer 41, which can greatly reduce the size of the spacer 41, reduce the bazel width, and ensure the cell assembly yield. The specific principle can be referred to the explanation above, and will not be repeated here.

Referring to FIG. 2, optionally, a plurality of first partitions 31 are arranged at intervals surrounding the display area AA. Such arrangement can reduce the influence of the first partition 31 on the fluidity of the sealant, avoiding the generation of sealant voids that affect the sealing effect.

Further, FIG. 10 is a schematic top view of another display module provided by an embodiment of the present disclosure. As shown in FIG. 10, optionally, the first partitions 31 are arranged along a second direction (such as the direction surrounding the display area AA) to form a partition unit group 301. Partition unit groups 301 are arranged along the first direction, the first direction intersects the second direction, and the first direction is the direction pointing from the display area AA to the non-display area NA. The partition unit groups 301 include a first partition unit group 3011 and a second partition unit group 3012. In the first direction, each first partition 31 in the first partition unit group 3011 overlaps a spacing between two adjacent first partitions 31 in the second partition unit group 3012.

Referring to FIG. 10, for purpose of distinction, FIG. 10 uses different fillings for the first partitions 31 in the first partition unit group 3011 and the second partition unit group 3012. Specifically, both the first partition unit group 3011 and the second partition unit group 3012 are arranged surrounding the display area AA, and they are arranged along the direction pointing from the display area AA to the non-display area NA. In this embodiment, by providing two partition unit groups 301 in the non-display area NA, and providing that the first partitions in the two partition unit groups 301 are arranged in a staggered manner, specifically, the first partition 31 in the first partition unit group 3011 overlaps the spacing between two adjacent first partitions 31 in the second partition unit group 3012, the gap area in one partition unit group 301 can be blocked by the first partition 31 in the other partition unit group 301. While not affecting the fluidity of the sealant, the sealing effect is improved, and it can also ensure that the sealant structure 40 at different positions has the support provided by the first partition 31 and the spacer 41, ensuring the structural stability of the electrophoresis cell.

Referring to FIG. 10, optionally, the first partition unit group 3011 is disposed at a side of the second partition unit group 3012 away from the display area AA. In the second direction (such as the Y direction), a length W1 of the first partition 31 in the first partition unit group 3011 is smaller than a length W2 of the first partition 31 in the second partition unit group 3012.

The second direction, in general, can be understood as the direction surrounding the display area AA. The direction of the second direction varies at different positions. Exemplarily, referring to FIG. 10, in the left and right bazel areas, the first direction specifically refers to the X direction shown in the figure, and the second direction specifically refers to the Y direction shown in the figure; in the upper and lower bazel areas, the first direction specifically refers to the Y direction shown in the figure, and the second direction specifically refers to the X direction shown in the figure. FIG. 10 only takes the left and right bazel areas as an example to mark the length of the first partition 31 in the second direction (such as the Y direction).

In this embodiment, by providing that the length W1 of the first partition 31 in the outer first partition unit group 3011 in the second direction is smaller than the length W2 of the first partition 31 in the inner second partition unit group 3012 in the second direction, the density of the first partitions 301 in the outer first partition unit group 3011 can be larger, which is beneficial to ensuring that the first partition 31 in the first partition unit group 3011 overlaps the spacing between two adjacent first partitions 31 in the second partition unit group 3012, thereby ensuring the sealing and supporting effects.

Referring to FIG. 10, optionally, along the first direction, a spacing (such as G2) between the first partition 31 in the first partition unit group 3011 and the first partition 31 in the second partition unit group 3012 is smaller than the maximum width of the spacer 41; and/or, along the second direction, a spacing (such as G3/G4) between two adjacent first partitions 31 in at least one of the first partition unit group 3011 and the second partition unit group 3012 is smaller than the maximum width of the spacer 41.

Referring to FIG. 10, along the first direction, the distance between the first partitions 31 in the first partition unit group 3011 and the second partition unit group 3012 is G2. Along the second direction, the spacing between two adjacent first partitions 31 in the first partition unit group 3011 is G3, and the distance between two adjacent first partitions 31 in the second partition unit group 3012 is G4. Referring to FIG. 8, the maximum width of the spacer 41 is L3.

Specifically, as a feasible implementation, G2<L3, and the relationship between G3 and G4 and the relationship between G3 and L3 are not limited. As another feasible implementation, G3<L3, and/or, G4<L3 (preferably G3<L3, and G4<L3), and the relationship between G2 and L3 is not limited. As another feasible implementation, G2<L3, G3<L3, and/or, G4<L3, preferably, G2<L3, G3<L3, and G4<L3. In this embodiment, by providing that the spacing (such as G2) between adjacent first partitions 31 in adjacent partition unit groups 301 is smaller than the maximum width of the spacer 41, and/or, by providing that the spacing between two adjacent first partitions 31 in the same partition unit group 301 is smaller than the maximum width of the spacer 41, it can be avoided that during the cell assembly process, the spacer 41 moves into the gap between two adjacent first partitions 31 in the first direction and/or the second direction, thereby avoiding the generation of sealant voids and ensuring the sealing effect.

Referring to FIG. 10, optionally, a length (such as W1) of the first partition 31 in the second direction (such as the Y direction) is larger than a length (such as L1) of the first partition 31 in the first direction (such as the X direction); the first direction intersects the second direction, and the first direction is the direction pointing from the display area AA to the non-display area NA.

Exemplarily, referring to FIG. 10, taking the first partition 31 in the first partition unit group 3011 in the left and right bazels as an example, the first direction is the X direction shown in the figure, and the second direction is the Y direction shown in the figure. The length W1 of the first partition 31 in the Y direction (second direction) is larger than the length L1 in the X direction (first direction). In general, referring to FIG. 2 and FIG. 10, regardless of the quantity of the partition unit groups 301 in the bazel area, any first partition 31 satisfies that the length in the direction surrounding the display area is larger than the length in the direction pointing from the display area to the non-display area. Such arrangement, on the one hand, can realize a narrow bazel design by providing that the first partition 31 has a smaller length in the direction pointing from the display area to the non-display area; on the other hand, by providing that the first partition 31 has a relatively larger length in the direction surrounding the display area, the first partition 31 can be ensured to have a larger coverage area, thereby ensuring the supporting effect.

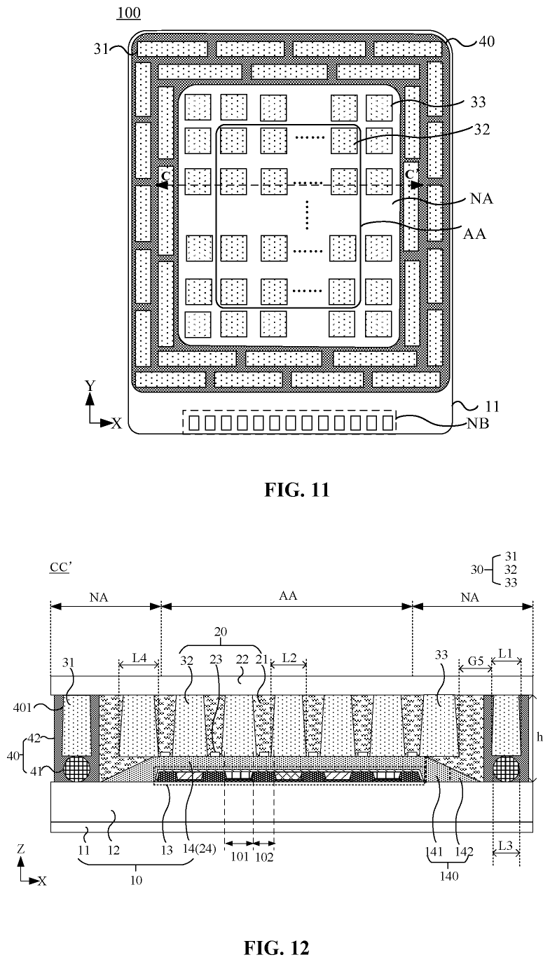

FIG. 11 is a schematic top view of another display module provided by an embodiment of the present disclosure, and FIG. 12 is a schematic cross-sectional view of the display module taken along CC′ in FIG. 11. As shown in FIG. 11 and FIG. 12, optionally, the display structure 10 includes a base substrate 11 and a thin film encapsulation layer 14 disposed between the base substrate 11 and the electrophoretic liquid layer 21; the thin film encapsulation layer 14 has a slope structure 140 in the non-display area NA; the slope structure 140 includes a first slope sub-portion 141 and a second slope sub-portion 142, the second slope sub-portion 142 is disposed at a side of the first slope sub-portion 141 away from the display area AA; in the direction Z perpendicular to the plane where the base substrate 11 is located, the thickness of the first slope sub-portion 141 is larger than the thickness of the second slope sub-portion 142, and the partitions 30 further includes a third partition 33; in the direction Z perpendicular to the plane where the display module is located, the third partition 33 overlaps the first slope sub-portion 141. The third partition 33 does not overlap at least part of the second slope sub-portion 142.

Specifically, the third partition 33 only overlaps the first slope sub-portion 141 and does not overlap the second slope sub-portion 142 at all; or, the third partition 33 overlaps the first slope sub-portion 141 and overlaps part of the second slope sub-portion 142. In general, a part of the slope structure 140 overlaps the third partition 33. Specifically, a part of the slope structure 140 close to the display area AA overlaps the third partition 33. It should be noted that the embodiment of the present disclosure does not limit whether the flat part of the thin film encapsulation layer 14 overlaps the third partition 33. FIG. 12 only illustrates the case where the third partition 33 overlaps the boundary line between the flat part and the slope part of the thin film encapsulation layer 14 as an example. In this case, the third partition 33 overlaps a part of the flat surface and a part of the slope of the thin film encapsulation layer 14.

It is found through research that in the photolithography process, if there is a large blank between different patterns, the height of the patterns in the pattern sparse area may differ from that in the pattern dense area, with the patterns in the pattern sparse area being lower in height. In this embodiment, the first partition 31 and the second partition 32 are formed by the same photolithography process. The first partition 31 is disposed in the non-display area NA, and the pattern density is relatively sparse. The second partition 32 is disposed in the display area AA and is provided corresponding to the pixel area 101, so the pattern density is relatively dense. The area between them has the slope structure 140 of the thin film encapsulation layer 14. The slope structure 140 has a certain width in the direction pointing from the display area AA to the non-display area NA, making the distance between the first partition 31 and the second partition 32 relatively large. In view of this, in this embodiment, by providing that the partitions 30 further include the third partition 33, and providing that the third partition 33 overlaps a part of the slope structure (such as the first slope sub-portion 141) of the thin film encapsulation layer 14 in the direction Z perpendicular to the plane where the display module is located, the distance between the partitions 30 in different areas can be shortened, ensuring the height consistency of the partitions 30 in different areas, so that the height of the first partition 31 is as consistent as possible with the height of the second partition 32, making the height of the first partition 31 in the bazel area as high as possible, thereby making the height of the spacer 41 as small as possible, further reducing the impact on cell assembly and reducing the bazel width.

Referring to FIG. 12, along the first direction (such as the X direction), a distance G5 between the third partition 33 and the first partition 31 is larger than the maximum width L3 of the spacer 41; the first direction is the direction pointing from the display area AA to the non-display area NA.

The distance in the first direction between the third partition 33 and the first partition 31 can be understood as the minimum distance between the nearest adjacent third partition 33 and first partition 31 in the first direction. Exemplarily, referring to FIG. 12, in the case where the cross-section of the partition 30 is a trapezoid narrow at the top and wide at the bottom, the distance between the third partition 33 and the first partition 31 specifically refers to the distance between the lower base of the trapezoid corresponding to the third partition 33 and the lower base of the trapezoid corresponding to the first partition 31.

In this embodiment, by providing that the distance G5 in the first direction between the third partition 33 and the first partition 31 is larger than the maximum width L3 of the spacer 41 in the first direction, during the cell assembly process, even if the spacer 41 moves to above the slope structure 140 of the thin film encapsulation layer 14, it can be ensured that the spacer 41 has enough moving space, avoiding the spacer 41 getting stuck on the slope structure 140 and affecting the cell assembly.

Referring to FIG. 12, optionally, along the first direction, a maximum width L4 of the third partition 33 is larger than the maximum width L2 of the second partition 32; the first direction is the direction pointing from the display area AA to the non-display area NA. Such arrangement can shorten the distance between the third partition 33 and the first partition 31 as much as possible, avoiding a large blank between the photolithography patterns, and ensuring the height consistency among the first partition 31, the second partition 32, and the third partition 33.

In other embodiments, the maximum width L4 of the third partition 33 can alternatively be smaller than or equal to the maximum width L2 of the second partition 32. In this way, a more sufficient moving space can be reserved for the spacer 41, ensuring the cell assembly yield.

In general, on the basis of ensuring that the distance G5 in the first direction between the third partition 33 and the first partition 31 is larger than the maximum width L3 of the spacer 41 in the first direction, the maximum width L4 of the third partition 33 in the first direction can be smaller than, equal to, or larger than the maximum width L2 of the second partition 32 in the first direction. The size relationship between the widths of the first partition 31 and the third partition 33 in the first direction is not limited in the present disclosure.

Referring to FIG. 11, in the second direction (the direction intersecting the first direction and surrounding the display area AA), FIG. 11 only illustrates the case where the width of the third partition 33 is equal to the width of the second partition 32 as an example. In other embodiments, the width of the third partition 33 in the second direction can alternatively be larger than the width of the second partition 32 in the second direction. The width of the third partition 33 in the second direction can be smaller than or equal to the width of the first partition 31 in the second direction, or can be larger than the width of the first partition 31 in the second direction, which is not limited in the embodiment of the present disclosure.

Referring to FIG. 12, optionally, the height of the third partition 33 is equal to the heights of the second partition 32 and the first partition 31.

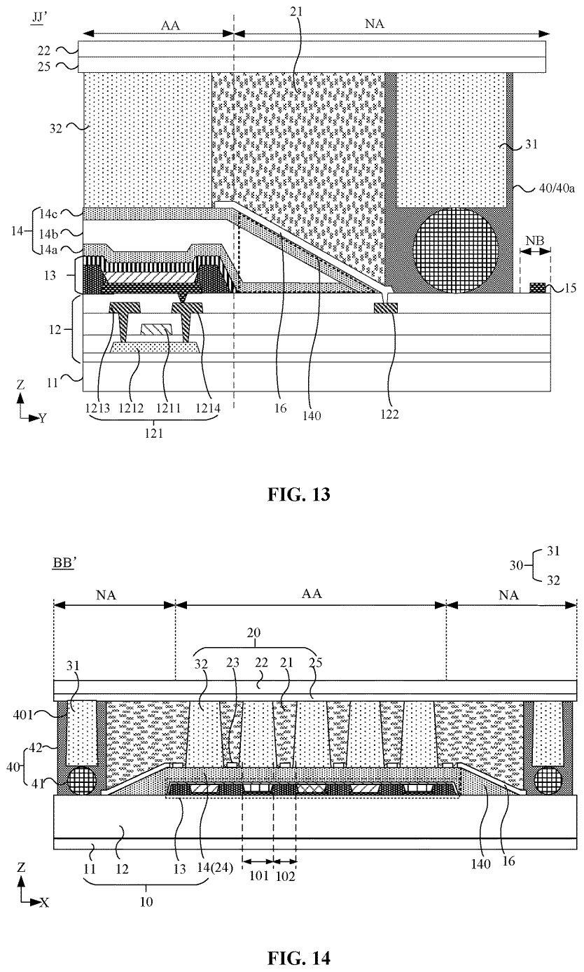

FIG. 13 is a schematic cross-sectional view of the display module taken along JJ′ in FIG. 2. As shown in FIG. 2 and FIG. 13, optionally, the non-display area NA includes a binding area NB. Along the direction pointing from the display area AA to the binding area NB, the sealant structure 40 includes a first sealant structure 40a disposed between the display area AA and the binding area NB.

Specifically, the binding area NB is provided with pads 15 for binding with a circuit board (not shown) and then being electrically connected to a driving chip through the circuit board. The binding area NB is usually disposed at the lower bazel. At the lower bazel, the sealant structure 40 (i.e., the first sealant structure 40a) is provided at a side of the binding area NB close to the display area AA, to expose the pads 15 in the binding area NB.

Referring to FIG. 13, optionally, a viewing angle control signal line 16 is provided at a side of the slope structure 140 of the thin film encapsulation layer 14 close to the electrophoretic liquid layer 21. The viewing angle control signal line 16 is electrically connected to the first electrode 23 (they can be integrally formed), for transmitting a viewing angle control signal to the first electrode 23, i.e., transmitting a suitable voltage to the first electrode 23 through the viewing angle control signal line 16, to realize wide/narrow viewing angle switching. The specific working principle is described in detail above, and will not be repeated here.

Exemplarily, referring to FIG. 13, the viewing angle control signal line 16 can be connected to an internal metal layer of the array layer 12 through a via hole, and then further wired through the internal metal layer of the array layer 12 until it is connected to the pad 15, so as to realize the signal connection between the driving chip and the viewing angle control signal line 16 through the pad 15 and the circuit board.

Referring to FIG. 13, optionally, the array layer 12 includes a thin film transistor 121. The thin film transistor 121 includes a gate 1211, an active layer 1212, a first electrode 1213, and a second electrode 1214. One of the first electrode 1213 and the second electrode 1214 is a source, and the other is a drain. The array layer 12 further includes a first transfer structure 122. The viewing angle control signal line 16 is electrically connected to the first transfer structure 122 through a via hole, and then electrically connected to the pad 15 through the first transfer structure 122. Optionally, the first transfer structure 122 is provided in the same layer as the first electrode 1213 and the second electrode 1214 of the thin film transistor 121. The metal used for the first electrode 1213 and the second electrode 1214 has a relatively high conductivity. Such arrangement is beneficial to reducing the transmission impedance of the viewing angle control signal.

Exemplarily, FIG. 14 is another schematic cross-sectional view taken along BB′ in FIG. 2. With reference to FIG. 13 and FIG. 14, optionally, in the slope structures 140 of the thin film encapsulation layer 14 at the left bazel, the right bazel, and the lower bazel, the viewing angle control signal lines 16 are provided at a side of the slope structures 140 away from the base substrate 11 (it can be understood that the upper bazel also has a slope structure, and the viewing angle control signal line is also arranged). The viewing angle control signal lines 16 at different positions are all electrically connected to the first electrode 23. Such arrangement is beneficial to the signal uniformity of the first electrodes 23 at different positions, thereby improving the display effect.

Referring to FIG. 13, in the case where the viewing angle adjustment structure includes the common electrode 25, optionally, the common electrode 25 is provided as a continuous layer. In the binding area NB, silver paste can be dispensed from the area where the common electrode 25 is disposed along the sidewall of the sealant structure 40 until the silver paste is electrically connected to the corresponding pad 15, realizing the transmission of the common signal from the driving chip to the common electrode 25 through the circuit board and the pad.

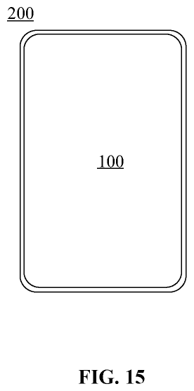

Based on the same inventive concept, an embodiment of the present disclosure further provides a display device. Exemplarily, FIG. 15 is a schematic structural diagram of a display device provided by an embodiment of the present disclosure. As shown in FIG. 15, the display device 200 includes the display module 100 provided in any of the above embodiments, and thus has the same beneficial effects as the above display module. The same parts can be referred to the description of the above embodiments and will not be repeated here. The display device 200 provided by the embodiment of the present disclosure can be a mobile phone as shown in FIG. 15, or can be any electronic product with a display function, including but not limited to the following categories: a television, a notebook computer, a desktop monitor, a tablet computer, a digital camera, a smart bracelet, smart glasses, a vehicle-mounted display, medical equipment, industrial control equipment, a touch interactive terminal, etc., which is not specially limited in the embodiment of the present disclosure.

The above specific implementations do not constitute a limitation on the protection scope of the present disclosure. It should be understood by those skilled in the art that various modifications, combinations, sub-combinations, and substitutions can be made according to design requirements and other factors. Any modification, equivalent replacement, and improvement made within the spirit and principle of the present disclosure shall fall into the protection scope of the present disclosure.

1. A display module comprising a display structure and a viewing angle adjustment structure disposed at a light-exiting side of the display structure, wherein
the display module comprises a display area and a non-display area at least partially surrounding the display area;
the viewing angle adjustment structure comprises an electrophoretic liquid layer and a first substrate disposed at a side of the electrophoretic liquid layer away from the display structure; the electrophoretic liquid layer comprises a plurality of electrophoretic particles, and the electrophoretic liquid layer is provided with partitions; the partitions comprise a first partition disposed in the non-display area and a second partition disposed in the display area; and
the display module further comprises a sealant structure disposed in the non-display area;
the sealant structure comprises a spacer, the sealant structure comprises an opening, and the first partition is disposed in the opening; wherein,
in a direction perpendicular to a plane where the display module is located, the first partition overlaps the spacer.

2. The display module according to claim 1, wherein along a first direction, a maximum width of the first partition is smaller than a maximum width of the second partition, where the first direction is a direction pointing from the display area to the non-display area.

3. The display module according to claim 1, wherein in the direction perpendicular to the plane where the display module is located, a height of the first partition is equal to a height of the second partition.

4. The display module according to claim 1, wherein a cross-section of the first partition taken along a first section plane is a first trapezoid, and a cross-section of the second partition taken along the first section plane is a second trapezoid; the first section plane is perpendicular to the plane where the display module is located; and
the first trapezoid comprises a first side and a second side and a first lateral side connecting the first side and the second side, the first side is at a side of the second side away from the first substrate, the second trapezoid comprises a third side and a fourth side and a second lateral side connecting the third side and the fourth side, the third side is at a side of the fourth side away from the first substrate; wherein,
an included angle between the first side and the first lateral side is α, an included angle between the third side and the second lateral side is β, and β<α≤90°.

5. The display module according to claim 1, wherein the display area comprises a pixel area and a non-pixel area, the partitions are each a light-transmitting structure, and along the direction perpendicular to the plane where the display module is located, the second partition overlaps the pixel area, and the electrophoretic liquid in the electrophoretic liquid layer overlaps the non-pixel area; and
the second partition comprises a first surface and a second surface, the first surface is at a side of the second surface away from the first substrate, and an area of the first surface is larger than an area of the second surface; an orthographic projection of the second surface on the display structure covers the pixel area.

6. The display module according to claim 1, wherein the display structure comprises a base substrate;
the first partition comprises a third surface and a fourth surface, the fourth surface is at a side of the third surface away from the base substrate; the sealant structure comprises a fifth surface and a sixth surface, the sixth surface is at a side of the fifth surface away from the base substrate; and
in a direction perpendicular to a plane where the base substrate is located, a distance between the fourth surface and the base substrate is equal to a distance between the sixth surface and the base substrate.

7. The display module according to claim 1, wherein along a first direction, a maximum width of the first partition is larger than a maximum width of the spacer, where the first direction is the direction pointing from the display area to the non-display area;
or
in the direction perpendicular to the plane where the display module is located, a height of the first partition is larger than a height of the spacer.

8. The display module according to claim 1, comprising a plurality of first partitions, wherein
the first partitions are arranged along a second direction to form partition unit groups, the partition unit groups are arranged along the first direction, the first direction intersects the second direction, and the first direction is the direction pointing from the display area to the non-display area; and
the partition unit groups comprise a first partition unit group and a second partition unit group, and in the first direction, one first partition in the first partition unit group overlaps a spacing between two adjacent first partitions in the second partition unit group.

9. The display module according to claim 8, wherein
the first partition unit group is disposed at a side of the second partition unit group away from the display area, and in the second direction, a length of each first partition in the first partition unit group is smaller than a length of each first partition in the second partition unit group.

10. The display module according to claim 8, wherein
along the first direction, a spacing between the first partition in the first partition unit group and the first partition in the second partition unit group is smaller than a maximum width of the spacer; and/or,
along the second direction, a spacing between two adjacent first partitions in at least one of the first partition unit group and the second partition unit group is smaller than the maximum width of the spacer.

11. The display module according to claim 1, wherein a length of the first partition in a second direction is larger than a length of the first partition in a first direction, where the first direction intersects the second direction, and the first direction is the direction pointing from the display area to the non-display area.

12. The display module according to claim 1, wherein
the display structure comprises a base substrate and a thin film encapsulation layer disposed between the base substrate and the electrophoretic liquid layer;
the thin film encapsulation layer has a slope structure in the non-display area; the slope structure comprises a first slope sub-portion and a second slope sub-portion, the second slope sub-portion is disposed at a side of the first slope sub-portion away from the display area; and
in a direction perpendicular to a plane where the base substrate is located, a thickness of the first slope sub-portion is larger than a thickness of the second slope sub-portion, and the first partition does not overlap the slope structure.

13. The display module according to claim 12, wherein the partitions further comprise a third partition;
in the direction perpendicular to the plane where the display module is located, the third partition overlaps the first slope sub-portion.

14. The display module according to claim 13, wherein along a first direction, a distance between the third partition and the first partition is larger than a maximum width of the spacer, where the first direction is the direction pointing from the display area to the non-display area;
or
along a first direction, a maximum width of the third partition is larger than a maximum width of the second partition, where the first direction is the direction pointing from the display area to the non-display area.

15. The display module according to claim 1, wherein the viewing angle adjustment structure further comprises a first electrode;
the first electrode is disposed at a side of the electrophoretic liquid layer close to the display structure; and
in the direction perpendicular to the plane where the display module is located, the first electrode does not overlap the second partition.

16. The display module according to claim 15, wherein the electrophoretic particles have a first state and a second state in the electrophoretic liquid of the electrophoretic liquid layer;
in the first state, the first electrode attracts the electrophoretic particles, and the electrophoretic particles gather in a first region of the electrophoretic liquid; the electrophoretic liquid further comprises a second region, the first region is at a side of the second region close to the display structure;
in the second state, the electrophoretic particles are freely distributed in the electrophoretic liquid; and
a viewing angle of the display module when the electrophoretic particles are in the first state is larger than a viewing angle of the display module when the electrophoretic particles are in the second state.

17. The display module according to claim 15, wherein the viewing angle adjustment structure further comprises a common electrode;
the common electrode is disposed at a side of the first substrate close to the electrophoretic liquid layer, and in the direction perpendicular to the plane where the display module is located, the common electrode at least overlaps the first electrode.

18. The display module according to claim 15, comprising more than one second partitions, wherein in a first direction, a spacing between two adjacent second partitions is larger than a width of the first electrode, where the first direction is the direction pointing from the display area to the non-display area.

19. The display module according to claim 1, wherein the non-display area comprises a binding area,
along a direction pointing from the display area to the binding area, the sealant structure comprises a first sealant structure disposed between the display area and the binding area.

20. A display device comprising a display module, the display module comprising a display structure and a viewing angle adjustment structure disposed at a light-exiting side of the display structure, wherein
the display module comprises a display area and a non-display area at least partially surrounding the display area;
the viewing angle adjustment structure comprises an electrophoretic liquid layer and a first substrate disposed at a side of the electrophoretic liquid layer away from the display structure; the electrophoretic liquid layer comprises a plurality of electrophoretic particles, and the electrophoretic liquid layer is provided with partitions; the partitions comprise a first partition disposed in the non-display area and a second partition disposed in the display area; and
the display module further comprises a sealant structure disposed in the non-display area;
the sealant structure comprises a spacer, the sealant structure comprises an opening, and the first partition is disposed in the opening; wherein,
in a direction perpendicular to a plane where the display module is located, the first partition overlaps the spacer.
